(19) United States
(12) Patent Application Publication
(10) Pub. No.: US 2007/0025708 A1
(43) Pub. Date: Feb. 1, 2007

(54) Wafer heating apparatus and method of setting the apparatus

(75) Inventors: Dong Woo Lee, Seoul (KR); Tae Gyu Kim, Hwaseong-si (KR); Jin Sung Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/483,879

(22) Filed: Jul. 11, 2006

(30) Foreign Application Priority Data
Aug. 1, 2005 (KR) 10-2005-70211

(51) Int. Cl. F26B 19/00; F26B 3/30

(52) U.S. Cl. 392/418

(57) ABSTRACT

A wafer apparatus including a heating plate, a case supporting and containing the heating plate, pressing arms laid across the case and the heating plate, and arm controlling units vertically moving the pressing arm toward the case. A plurality of the pressing arms and the arm controlling units are disposed along the circumference of the heating plate and may compensate a portion protruded upward due to the warpage of the heating plate by pressurizing. The warpage of the heating plate can be effectively compensated, and a wafer can be heated with a uniform temperature.

### CROSS-REFERENCE TO RELATED APPLICATIONS

This application claims the benefit of Korean Patent Application No. 2005-70211, filed on Aug. 1, 2005, in the Korean Intellectual Property Office, the disclosure of which is incorporated herein in its entity by reference.

### BACKGROUND OF THE INVENTION

1. Field of the Invention

The present invention relates to a wafer heating apparatus, and more particularly, to a wafer heating apparatus and a method of setting the same, in which warpage of a plate, generated due to thermal deformation or the change of pressure is rectified.

2. Description of the Related Art

Generally, a process of heating a wafer is frequently performed in manufacturing semiconductor devices. For example, a photolithography process includes sensitizing, exposing, developing, and etching. In this case, pre-baking and post exposure baking (PEB) may be respectively performed before and after the exposing. The described heating processes increase adhesive strength between the sensitizer applied before the etching or the developing and a wafer.

To heat a wafer, the wafer is put on a general heating apparatus and receives heat from a heating plate to maintain desirable temperature. The heating plate has to precisely and uniformly control the temperature of the wafer. For example, in a process of manufacturing a semiconductor device using a wafer of approximately 12 inches, the temperature of the wafer has to be controlled to within approximately 0.2° C. and the temperature of the whole wafer has to be substantially uniformly maintained during heating or cooling. Also, since current ceramic heating plates whose thickness are approximately 3 to 4 mm are used, a heating apparatus may quickly and precisely control the temperature of a wafer.

FIG. 1 is a bottom view illustrating a conventional ceramic heating plate.

Referring to FIG. 1, a conventional ceramic heating plate 10 includes a ceramic disk 12 and a heating pattern 14 formed on the bottom of the disk 12. The ceramic disk 12 may have a diameter that can support the whole of a wafer and be formed in the thickness of approximately 3 mm. The heating pattern 14 is formed on the bottom of the ceramic disk 12 as a heating resistor. The heating pattern 14 may be formed on the bottom of the ceramic disk 12 by screen printing or etching and formed in one or several heating patterns.

As described above, the heating plate 10 has to control the temperature of a wafer to be substantially uniform. Accordingly, a plurality of heating patterns 14 may be formed on the bottom of the ceramic disk 12, and each of the heating patterns 14 controls the temperature of the wafer for each zone, thereby controlling the temperature of the wafer to be uniform. However, the heating patterns 14 may be formed to be symmetric/asymmetric and the heating plate 10 may be warped during the manufacturing of the heating plate 10.

FIG. 2 is a 3-dimensional diagram illustrating warpage of a conventional ceramic heating plate.

Referring to FIG. 2, a heating plate is entirely warped and two peaks are formed at approximately 180° from each other and two valleys are also formed at approximately 180° from each other.

Generally, to manufacture a heating plate, a heating pattern is formed on the bottom of a ceramic disk and a plasticity process of the heating plate is performed at approximately 800° C. After the plasticity process, the ceramic disk may contract and become deformed. In this case, the distortion of the heating plate, described above, may occur due to the heating pattern. The warpage of the heating plate shown in FIG. 2 may occur not only during the manufacturing process but also during the frequent heating and cooling of the heating plate for heating a wafer in a semiconductor manufacturing process.

A distorted heating plate may cause heterogeneous distribution of the interval between the heating plate and wafer, and the heterogeneous interval distribution may prevent controlling the uniformity of the temperature of the wafer. Accordingly, warpage of a heating plate caused by the plasticity process or other factors has to be rectified.

### SUMMARY OF THE INVENTION

The present invention provides a wafer heating apparatus that can form uniform interval distribution between a heating plate and a wafer by rectifying warpage of the heating plate.

The present invention also provides a wafer heating apparatus that can easily rectify warpage by controlling the flatness of the entire heating plate.

The present invention also provides a wafer heating apparatus of various structures which can control the flatness of a heating plate.

The present invention also provides a method of setting a wafer heating apparatus capable of rectifying the warpage of a heating plate.

According to an aspect of the present invention, there is provided a wafer heating apparatus which includes a heating plate, a case, a pressing arm, and an arm controlling unit. The heating plate may be composed of ceramic or material that can replace ceramic. The case includes a bottom casing and a side casing to support and contain the heating plate. The heating plate may be substantially formed in the shape of a circular disk corresponding to the form of a wafer. The case may provide the bottom casing and side casing separately, or the case may be formed as a single unit.

The wafer heating apparatus includes the pressing arm for partially pressurizing a peak of a warped heating plate or a portion adjacent to the peak and the arm controlling unit for controlling the level or pressure of the pressing arm. One or more pressing arms are located on the boundary between the side casing and the heating plate and disposed across the side casing and the heating plate. Each of the pressing arms may be in contact with the top of the heating plate by different pressure and may pressurize the peak of the heating plate, thereby maintaining approximately uniform flatness of the heating plate.

To control the level of the pressing arms, the arm controlling unit may have various structures. For example, the pressing arm may be moved as a lever and an adjusting bolt may control the height of the pressing arm to control the force pressing the top of the heating plate. Otherwise, the pressing arm may be horizontally moved to control the height of the top of the heating plate.

An adiabatic contacting portion may be interposed between the pressing arm and the heating plate. More particularly, the adiabatic contacting portion is placed below the end portion of the pressing arm, to block the heat transmission between the pressing arm and the heating plate. The adiabatic contacting portion may be formed in the shape of a ball or a circular truncated cone and may transmit the pressure of the pressing arm to the heating plate.

According to another aspect of the present invention, there is provided a wafer heating apparatus that may include a heating plate, a case, a pressing holder, and a holder controlling unit. The previous pressing arm pressurizes the top of the heating plate to press the peak of the heating plate only downward. On the other hand, the pressing holder is engaged with the top and bottom of the heating plate, thereby pressing the peak of the heating plate or lifting the valley of the heating plate. Accordingly, the evenness of the heating plate may be variously controlled.

The wafer heating apparatus may be set up by a method including the operations of providing a heating plate beneath which a resistance heating element is formed; putting the heating plate in a case including a containing space formed to contain the heating plate; disposing a plurality of pressing arms above the case and the heating plate along the boundary of the case and the heating plate; fastening the pressing arm to the case by using an arm controlling unit; measuring the height of the top surface of the heating plate along the edges of the heating plate; and controlling the height of the top surface of the heating plate to be within a predetermined tolerance by vertically moving the pressing arm with respect to the case by the arm controlling unit according to the measured result. A user may perform the operations of measuring and controlling the height of the heating plate, one by one or at the same time. The heating plate may be controlled to be flat within the tolerance determined as a standard via the described process.

Additional aspects and/or advantages of the invention will be set forth in part in the description which follows and, in part, will be apparent from the description, or may be learned by practice of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a bottom view illustrating a conventional ceramic heating plate;

FIG. 2 is a 3-dimensional diagram illustrating warpage of a conventional ceramic heating plate;

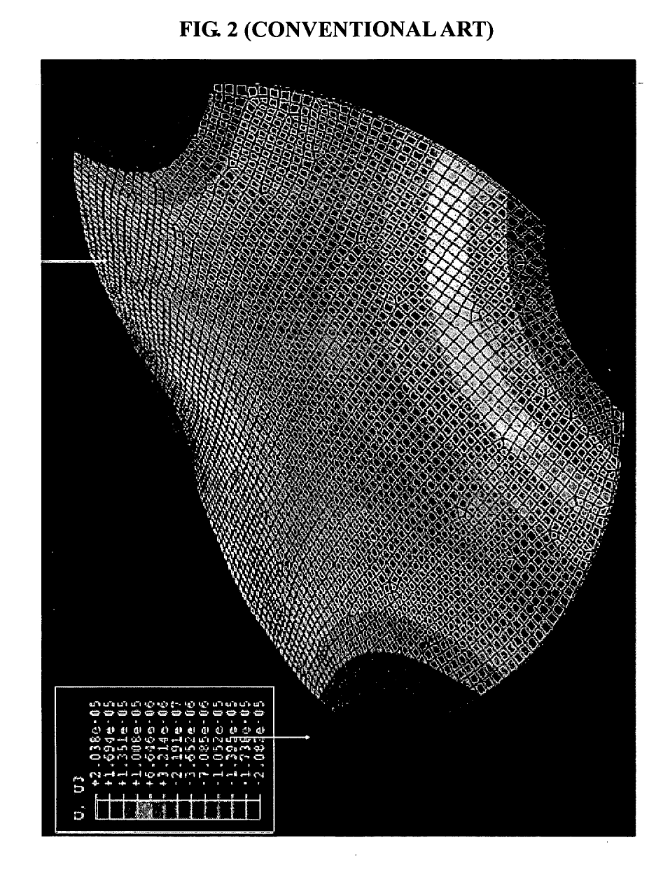

FIG. 3 is a cross-sectional view of a wafer heating apparatus according to an embodiment of the present invention;

FIG. 4 is a partial enlarged view illustrating a coupling relation between a heating plate and a pressing arm of FIG. 3;

FIG. 5 is a top view illustrating the wafer heating apparatus according to an embodiment of the present invention and a method of setting the wafer heating apparatus;

FIG. 6 is a partial enlarged view illustrating a coupling relation between a heating plate and a pressing arm of a wafer heating apparatus according to another embodiment of the present invention; and

FIG. 7 is a partial enlarged view illustrating a coupling relation between a heating plate and a pressing arm of a wafer heating apparatus according to still another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

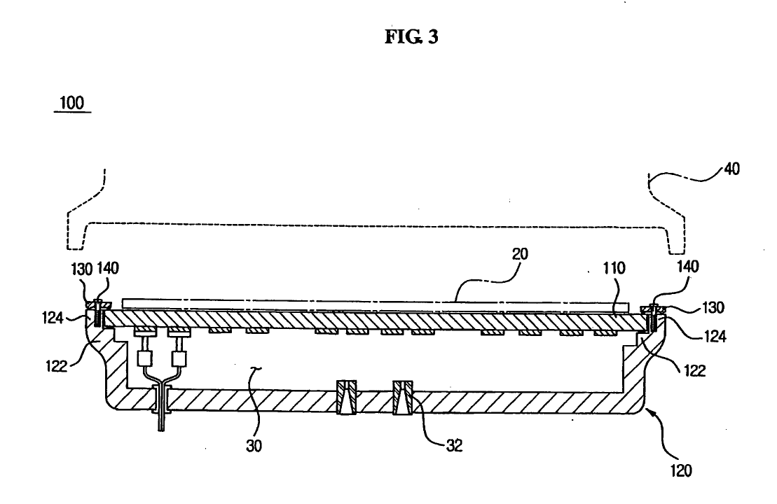

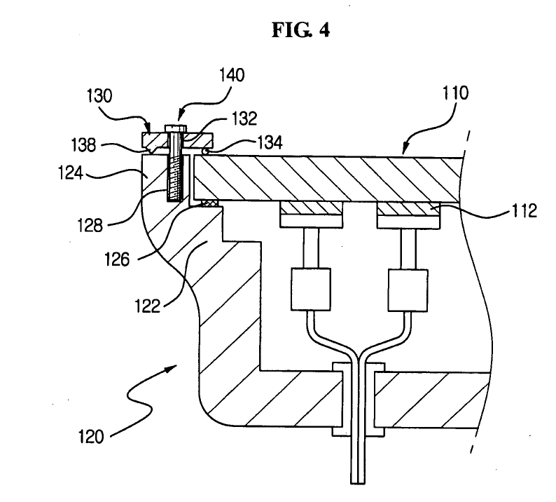

FIG. 3 is a cross-sectional view of a wafer heating apparatus according to an embodiment of the present invention, and FIG. 4 is a partial enlarged view illustrating a coupling relation between a heating plate and a pressing arm of FIG. 3.

Referring to FIGS. 3 and 4, a wafer heating apparatus 100 includes a heating plate 110, a case 120, pressing arms 130, and adjusting bolts 140. The case 120 supports the heating plate 110 and includes a space in the shape of a disk for containing the heating plate 110. The heating plate 110 may be securely disposed in the space, and the pressing arm 130 and the adjusting bolt 140 may fasten the heating plate 110 onto the case 120. Particularly, in the wafer heating apparatus 100, the adjusting bolt 140 may control the level or the height of the pressing arm 130, thereby compensating for the warpage of the heating plate 110.

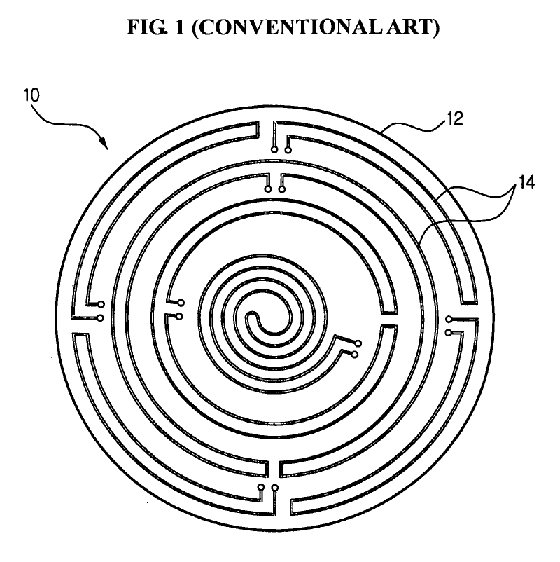

The heating plate 110 is composed of ceramic or material that can replace ceramic and may support a wafer 20 on the top surface. A heating pattern 112 is formed on the bottom surface of the heating plate, opposite to the wafer 20. The heating pattern 112 may increase or decrease the temperature of the heating plate 110 under the control of an electrically connected external apparatus. Generally, as illustrated in FIG. 1, a plurality of the heating patterns 112 may form a heating zone separated from each other respectively. Since the heating patterns 112 control the temperature of the heating plate 110 for each zone, the wafer heating apparatus 100 may maintain a constant temperature of the heating plate 110 regardless of the zone and may quickly change the temperature of the plate corresponding to external control. Though the heating plate 110 is formed in the shape of a disk corresponding to the shape of a wafer 20, the heating plate 110 may be manufactured in various shapes and thicknesses according to use or circumstance.

The case 120 is provided to contain and support the heating plate 110. The case 120 includes a bottom casing 122 and a side casing 124. The bottom casing 122 is formed smaller than the outer diameter of the heating plate 110 and may support the edge of the bottom of the heating plate 110. Also, the side casing 124 contains the side of the outer circumference of the heating plate 110 and may be closely or separately disposed along the heating plate 110. In the present embodiment, the inner surface of the side casing 124 is also formed in a circle corresponding to the shape of the heating plate 110 and has a height similar to the heating plate 110.

As illustrated in FIG. 3, the space between the case 120 and the heating plate 110 may form a cooling chamber 30. A cooling gas, passing in and out of the cooling chamber through nozzles 32, may be used for rapidly lowering the temperature of the heating plate 110 and may cool the heating plate 110.

To maintain a hermetically sealed cooling chamber 30, a sealing element 126 may be interposed between the bottom casing 122 of the case 120 and the edge of the heating plate 110. The sealing element 126 may be composed of elastic and flexible material such as rubber and is formed in the shape of a ring or wire to hermetically seal the space between the case 120 and the heating plate 110. Also, since the case 120 is generally composed of metal such as aluminum, the sealing element 126 may be adiabatic. In case that the sealing element 126 is insufficiently adiabatic, heat may be transmitted from the heating plate 110 to the case 120 via the sealing element 126, thereby forming unstable temperature distribution from the edge of the heating plate 110 due to the loss of heat.

Referring to FIG. 4, the pressing arm 130 is disposed across between the side casing 124 and the heating plate 110 and is laid across the side casing 124 and the heating plate 110. Also, the pressing arm 130 and the side casing 124 are connected to each other by the adjusting bolt 140. The adjusting bolt 140 may not only fasten the pressing arm 130 to the side casing 124 but also control the force of pressing on the edge of the heating plate 110.

The pressing arm 130 is formed in the shape of a right hexahedron and includes a penetrating hole 132 for passing the adjusting bolt 140. Also, a pivot protrusion 138 is formed on the bottom surface of the pressing arm 130. The pressing arm 130 is in contact with the side casing 124 by the pivot protrusion 138. The pressing arm 130 may be pivoted on the surface which is in contact with the pivot protrusion 138. Corresponding to the adjusting bolt 140, an adjusting hole 128 is formed on the top of the side casing 124, and a female screw corresponding to the adjusting bolt 140 is formed in the adjusting hole 128 to control the size of the gap of the pressing arm 130 and the side casing 124. Also, an adiabatic contacting portion 134 is provided on the bottom surface of an end of the pressing arm 130, which is in contact with the heating plate 110. The adiabatic contacting portion 134 may be formed in the shape of a ball, a cylindrical truncated cone, or a frustum of a pyramid and be in contact with the heating plate 110. The adiabatic contacting portion 134 is also composed of adiabatic material, thereby preventing heat from leaking out from the heating plate 110.

The pressing arm 130 may be pivoted on the pivot protrusion 138 as a lever, and the adjusting bolt 140 may control the pressurizing force of the pressing arm 130 pressing the heating plate 110. Though a conventional structure for pressing a heating plate is already disclosed, the conventional structure is only for fixing a heating plate without separation from its container and not for controlling the flatness of the heating plate. Also, the conventional structure for fixing a heating plate does not have an ability for vertical movement and is just fastened to a certain location. However, the pressing arm 130 according to the present embodiment may allow for movement in the vertical direction by using the pivot protrusion 138 and may precisely compensate for warpage of a plate by pressing the peak of the heating plate 110, which is protruded due to the warpage, by intentional displacement of the pressing arm 130.

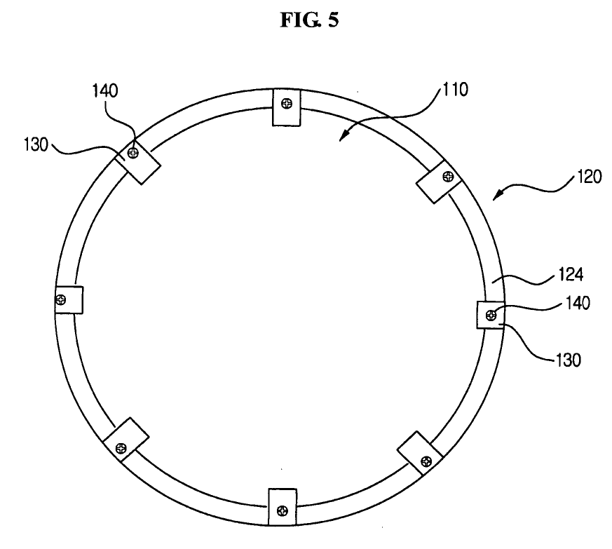

FIG. 5 is a top view illustrating the wafer heating apparatus according to an embodiment of the present invention and a method of setting the wafer heating apparatus.

Referring to FIG. 5, the heating plate 110 is put on the case 120 and eight pressing arms 130 are provided along the boundary between the heating plate 110 and the case 120. The adjusting bolt 140 including a bolt head and a body is provided for each of the 8 pressing arms 130. Generally, since warpages of the heating plate 110 are formed in an even number such as 2, 4, 6, etc., the pressing arms 130 may also be provided by an even number such as 6, 8, 10, etc., and uniformly disposed on the side casing 120.

The pressing arms 130 are laid across the heating plate and the case 120 and provided at identical intervals. The pressing arms 130 are fastened to the casing 120 by the adjusting bolt 140. Next, a user may measure the evenness of the top surface of the heating plate 110 by using a height measuring instrument. Since the warpage of the heating plate 110 occurs mainly along the edges of the heating plate 110, if the height is measured along the edges of the heating plate 110, the maximal deformation displacement value and the location of the peak of the heating plate 110 may be recognized.

According to a result of measuring the height, the user may compensate for a difference of the height of the heating plate 110 by using the adjusting bolt 140 and the pressing arm 130. In this case, it is preferable to form the heating plate 110 as a perfectly flat surface, which is impossible in practice. In practice, a heating plate is regarded as a flat surface when the difference of the height is measured to be within a certain tolerance. For example, a heating plate for applying heat to a wafer of 12 inches is regarded as a flat surface in case that the difference of the height is measured to be within the range of approximately 20 μm. A procedure of measuring the height and adjusting the level of the pressing arms 130 by using the adjusting bolt, as described above, may be repeated several times.

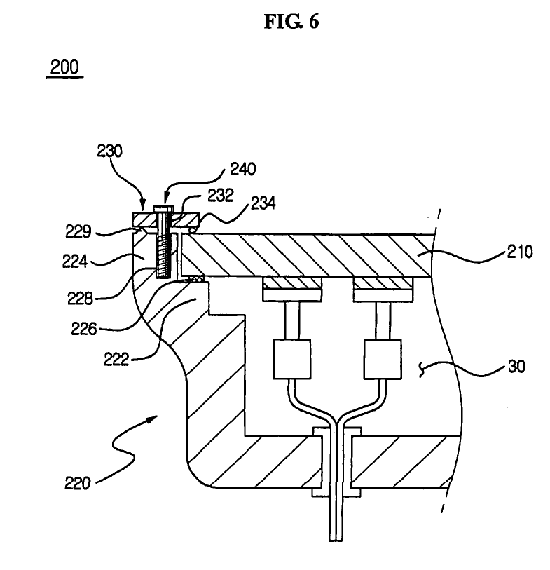

FIG. 6 is a partial enlarged view illustrating a coupling relation between a heating plate and a pressing arm of a wafer heating apparatus according to another embodiment of the present invention. For reference, in FIG. 6, a specific portion is enlarged and the description and drawings of the previous embodiments may be referred to with respect to other elements.

Referring to FIG. 6, a wafer heating apparatus 200 includes a heating plate 210, a case 220, a pressing arm 230, and an adjusting bolt 240. The case 220 supports the heating plate 210, and the heating plate 210 is securely disposed in a space formed at the center of the case 220. The pressing arm 230 and the adjusting bolt 240 may fasten the heating plate 200, securely disposed on the case 220 and compensate for the warpage of the heating plate 210.

The heating plate 210 is composed of ceramic or material that may replace ceramic, and the case 220 contains and supports the heating plate 210. The case 220 includes a bottom casing 222 and a side casing 224 and is formed in the shape of a circle corresponding to the shape of the heating plate 210. Also, a cooling chamber 30 is provided by the case 220 and the heating plate 210. The heating plate 210 defines the upper boundary of the cooling chamber 30 and the case 220 defines the lower boundary of the cooling chamber 30. To maintain a hermetically sealed cooling chamber 30, a sealing element 226 may be interposed between the bottom casing 222 of the case 220 and the edge of the heating plate 210. The sealing element 226 may be composed of an elastic and flexible material such as rubber and may be adiabatic to prevent the loss of heat.

As illustrated in FIG. 6, the pressing arm 230 is located on the boundary of the side casing 224 and the heating plate 210 and laid across the side casing 224 and the heating plate 210. Also, the pressing arm 230 and the side casing 224 are connected to each other by the adjusting bolt 240. The adjusting bolt 240 may not only fasten the pressing arm 230 to the casing 220 but also control the force of pressing on the edge of the heating plate 210.

The pressing arm 230 is formed in the shape of a right hexahedron and includes a penetrating hole 232 for passing the adjusting bolt 240. Also, a pivot protrusion 229 is formed on the top of the side casing 224. The pressing arm 230 is in contact with the side casing 224 by the pivot protrusion 229. The pressing arm 230 may be pivoted on the surface which is in contact with the pivot protrusion 229. Corresponding to the adjusting bolt 240, an adjusting hole 228 is formed on the top of the side casing 224, and a female screw corresponding to the adjusting bolt 240 is formed in the adjusting hole such that the gap between the pressing arm 230 and the side casing 240 is controlled. Also, in the pressing arm 230, an adiabatic contacting portion 234 is provided on the bottom surface of an end in contact with the heating plate 210. The adiabatic contacting portion 234 may be formed in the shape of a ball, a circular truncated cone, or a frustum of a pyramid and is in contact with the heating plate 210. The adiabatic contacting portion 234 is composed of adiabatic material, thereby preventing heat leakage.

The pressing arm 230 may be pivoted on the pivot protrusion 229, such as a lever, and the adjusting bolt 240 may control the amount of pressure exerted by the pressing arm 230 pressing on the heating plate 210 by controlling the length of being fastened in the adjusting hole 228. The pressing arm 230 may allow of movement in the vertical direction by using the pivot protrusion 229 and may precisely compensate for warpage of a plate by pressing a peak of the heating plate 210.

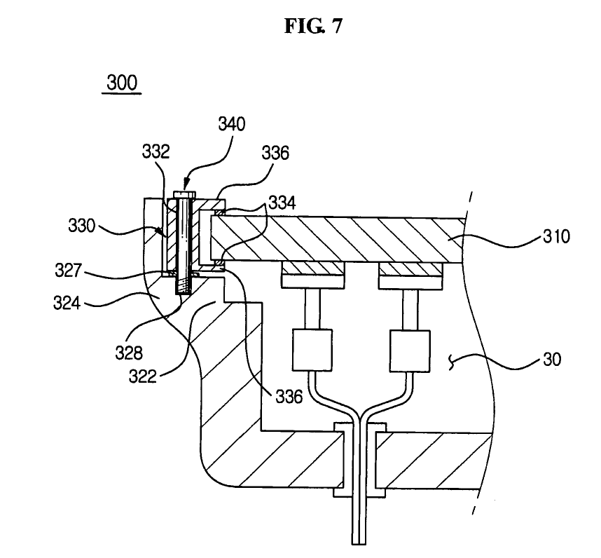

FIG. 7 is a partial enlarged view illustrating a coupling relation between a heating plate and a pressing arm of a wafer heating apparatus according to still another embodiment of the present invention. For reference, in FIG. 7, a specific portion is enlarged and the description and the drawings of the previous embodiments may be referred to with respect to other elements.

Referring to FIG. 7, a wafer heating apparatus 300 includes a heating plate 310, a case 320, a pressing holder 330, and an adjusting bolt 340. The case 320 supports the heating plate 310, and the heating plate 310 and the pressing holder 330 are securely disposed in a space formed at the center of the case 320. The pressing holder 330 and the adjusting bolt 340 may fasten the heating plate 310 to the case 320 in the space and compensate for warpage of the heating plate 320.

The heating plate 310 is composed of ceramic or material that can replace ceramic. The case 320 contains and supports the heating plate 310. The case 320 includes a bottom casing 322 and a side casing 324 and is formed in the shape of a circle corresponding to the shape of the heating plate 310. A plurality of pressing holders 330 are arranged at uniform intervals along the circumference of the heating plate 310. Each of the pressing holders 330 is fastened to the bottom casing 322. In the present embodiment, the side casing 324 may exist to insulate the heating plate 310 and the pressing holder 330 from the outside. However, the side casing 324 may be omitted.

The pressing holder 330 is disposed above the bottom casing 322 and is in contact with the top and bottom of the heating plate 310 to fasten the heating plate 310. Also, the pressing holder 330 and the bottom casing 322 are fastened together by the adjusting bolt 340. In the previous embodiments, the pressing arm 130 and 230 can exert downward pressure on the heating plate 110 and 210. In the present embodiment, the pressing holder 330 may exert pressure on the heating plate 310 upward and downward.

The pressing holder 330 includes pressurizing portions 336 for fastening the heating plate 310, and the pressurizing portions 336 are protruded from the side of the top and bottom of the body of the pressing holder 330 to partially contain the edge of the heating plate 310. Also, in the pressing holder 330, an adiabatic contacting portion 334 is provided on the pressurizing portions 336 to be in contact with the heating plate. The adiabatic contacting portions 334 may be formed in the shape of a ball, a circular truncated cone, or a frustum of a pyramid and are interposed between the pressurizing portion 336 and the heating plate 310, respectively. The adiabatic contacting portion 334 is composed of adiabatic material, thereby preventing heat leakage.

The pressing holder 330 includes a penetrating hole 332 for passing the adjusting bolt 340. Also, corresponding to the adjusting bolt 340, an adjusting hole 328 is formed on top of the bottom casing 322, and a female screw corresponding to the adjusting bolt 340 is formed in the adjusting hole 328 to control the gap between the pressing holder 330 and the bottom casing 322. A spring washer 327 is interposed around the adjusting bolt 340 between the pressing holder 330 and the bottom casing 322, to serve as a gap buffering element and elastically support the pressing holder 330. The spring washer 327 can provide resistance to the adjusting bolt to enhance the bolting by the adjusting bolt.

The pressing holder 330 may be vertically adjusted by the adjusting bolt 340, the adjusting hole 328, and the spring washer 327, and not only the amount but also the direction of pressing the heating plate 310 may be controlled. Accordingly, the pressing holder 330 may adjust not only a peak but also a valley of the heating plate 310, which are formed due to warpage, by intentional displacement and may effectively compensate for the warpage of the plate.

As described above, the heating apparatus of the present invention can effectively compensate for the warpage of the heating plate and maintain the top of the heating plate to be sufficiently horizontally even to maintain a uniform distance from a wafer. Accordingly, the heating plate can maintain the temperature of the wafer and be applied to the entire wafer used in manufacturing a product, thereby improving the yield of semiconductor devices.

Also, the heating apparatus can easily remove all warpage by controlling the evenness of the entire heating plate. Particularly, the evenness of the heating plate may be easily controlled by disposing a proper number of pressing arms or pressing holders in a proper position. In this case, the pressing holder can effectively compensate for warpage of the heating plate by moving vertically for compensation.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A wafer heating apparatus comprising:
a heating plate;
a case including a bottom casing supporting the edges of the bottom surface of the heating plate and a side casing containing the side surface of the heating plate;
a pressing arm disposed across the side casing and the heating plate; and
an arm controlling unit vertically moving the pressing arm with respect to the side casing to control the height of the top surface of the heating plate.

2. The apparatus of claim 1, wherein a sealing element is interposed between the bottom casing and the heating plate.

3. The apparatus of claim 1, wherein:
the arm controlling unit includes an adjusting bolt;
the pressing arm includes a penetrating hole vertically penetrating, corresponding to the adjusting bolt;
an adjusting hole including a female screw for the adjusting bolt is formed on the top of the side casing; and
the pressuring of the pressing arm is controlled by using the adjusting bolt.

4. The apparatus of claim 1, wherein an adiabatic contacting portion is provided below an end portion of the pressing arm in contact with the heating plate.

5. A wafer heating apparatus comprising:
a heating plate;
a case including a bottom casing supporting the edges of the bottom surface of the heating plate and a side casing containing the side surface of the heating plate;
a pressing arm disposed above the side casing and the heating plate and including a pivot protrusion protruded toward the side casing; and
an arm controlling unit vertically moving the pressing arm pivoted on the pivot protrusion in contact with the side casing.

6. The apparatus of claim 5, wherein a sealing element is interposed between the bottom casing and the heating plate.

7. The apparatus of claim 5, wherein:
the arm controlling unit includes an adjusting bolt;
the pressing arm includes a penetrating hole vertically penetrating, corresponding to the adjusting bolt;
an adjusting hole including a female screw for the adjusting bolt is formed on the top of the side casing; and
the pressing arm pressing or releasing the edges of the heating plate by the adjusting bolt.

8. The apparatus of claim 5, wherein an adiabatic contacting portion is provided below an end portion of the pressing arm, in contact with the heating plate.

9. A wafer heating apparatus comprising:
a heating plate;
a case including a bottom casing supporting the edges of the bottom surface of the heating plate and a side casing containing the side surface of the heating plate, in which a pivot protrusion is formed on the side casing;
a pressing arm disposed above the side casing and the heating plate and pointedly supported by the pivot protrusion; and
an arm controlling unit vertically moving the pressing arm pivoted on the pivot protrusion to press the top surface of the heating plate.

10. The apparatus of claim 9, wherein a sealing element is interposed between the bottom casing and the heating plate.

11. The apparatus of claim 9, wherein:
the arm controlling unit includes an adjusting bolt;
the pressing arm includes a penetrating hole vertically penetrating, corresponding to the adjusting bolt;
an adjusting hole including a female screw for the adjusting bolt is formed on the top of the side casing; and
the pressing arm pressing or releasing the edges of the heating plate by using the adjusting bolt.

12. The apparatus of claim 9, wherein an adiabatic contacting portion is provided below an end portion of the pressing arm, in contact with the heating plate.

13. A wafer heating apparatus comprising:
a heating plate in the shape of a disk, beneath which a resistance heating element is formed;
a case including a bottom casing supporting the edges of the bottom surface of the heating plate and a side casing containing the side surface of the heating plate, in which a plurality of adjusting holes are formed at uniform intervals on the side casing and a female screw is formed on the inner surface of each of the adjusting holes;
a plurality of pressing arms disposed above the side casing and the heating plate, including a penetrating hole vertically penetrating, and disposed along the circumference of the heating plate such that the penetrating hole is in accordance with the adjusting hole; and
an adjusting bolt including a bolt head having a size greater than the penetrating hole and a bolt body passing through the penetrating hole and fastened in the adjusting hole.

14. The apparatus of claim 13, wherein a sealing element is interposed between the bottom casing and the heating plate.

15. The apparatus of claim 13, wherein an adiabatic contacting portion is provided below an end portion of the pressing arm in contact with the heating plate.

16. A wafer heating apparatus comprising:
a heating plate;
a pressing holder engaged with the edges of the top surface and the bottom surface of the heating plate;
a case supporting the heating disk and the pressing holder; and
a holder controlling unit vertically moving the pressing holder with respect to the case to control the height of a clamped portion of the heating plate.

17. The apparatus of claim 16, wherein:
the holder controlling unit includes an adjusting bolt;
the pressing holder includes a penetrating hole vertically penetrating, corresponding to the adjusting bolt;
an adjusting hole including a female screw for the adjusting bolt is formed in the case; and
the height of the pressing holder in contact with the heating plate is controlled by using the adjusting bolt.

18. The apparatus of claim 17, wherein a spring washer containing the adjusting bolt is provided between the pressing holder and the case.

19. The apparatus of claim 16, wherein an adiabatic contacting portion is provided on an end portion of the pressing holder, which is in contact with the top surface and the bottom surface of the heating plate.

20. The apparatus of claim 16, wherein a gap buffering element is interposed between the pressing holder and the case.

21. A method of setting a wafer heating apparatus, comprising:
providing a heating plate beneath which a resistance heating element is formed;
putting the heating plate on a case, the case including a containing space formed to contain the heating plate;
disposing a plurality of pressing arms above the case and the heating plate along the boundary of the case and the heating plate;
fastening the pressing arm to the case by using an arm controlling unit;
measuring the height of the top surface of the heating plate along the edges of the heating plate; and
controlling the evenness of the top surface of the heating plate within a predetermined tolerance by vertically moving the pressing arm with respect to the case by the arm controlling unit according to the measured result.

22. The apparatus of claim 21, wherein:
fastening the pressing arm to the case includes forming a penetrating hole penetrating the pressing arm and fastening an adjusting bolt passing through the penetrating hole with an adjusting hole of the case; and
controlling the evenness of the top surface of the heating plate within the predetermined tolerance includes searching a peak position where the edge of the heating plate is relatively higher than its vicinities and rotating the adjusting bolt located closest to the peak position to press a part of the edge of the heating plate.
